(19) United States
(12) Patent Application Publication
(10) Pub. No.: US 2015/0107750 A1
(43) Pub. Date: Apr. 23, 2015

(54) METHOD AND APPARATUS FOR LAMINATING SCINTILLATOR PANEL AND IMAGING DEVICE PANEL

(71) Applicants: Yun Sung Huh, Anyang-si (KR); Tae Kwon Hong, Seongnam-si (KR); Gi Youl Han, Cheonan-si (KR)

(72) Inventors: Yun Sung Huh, Anyang-si (KR); Tae Kwon Hong, Seongnam-si (KR); Gi Youl Han, Cheonan-si (KR)

(21) Appl. No.: 14/060,078

(22) Filed: Oct. 22, 2013

(51) Int. Cl. G01T 1/20; B32B 37/10

(52) U.S. Cl. CPC G01T 1/2006; B32B 37/1018
USPC 156/64; 156/285; 156/382; 156/378

(57) ABSTRACT

An apparatus for laminating a scintillator panel and an imaging device panel includes a chamber, a membrane, a first vacuum pump, a second vacuum pump, a heater plate, and a heater power supply. The chamber includes a chamber cover, defining a sealed space. The membrane defines the sealed space in the bottom of the chamber cover by being coupled to the bottom surface of the chamber cover and is made of a contractable and expandable material. The first vacuum pump is coupled to the chamber cover and vents vacuum in the sealed space between the bottom surface of the chamber cover and the membrane. The second vacuum pump vents vacuum in the chamber by being coupled to one side of the chamber. The heater plate is coupled into the chamber to support and heat the panel assembly with an adhesive interposed between the scintillator panel and the imaging device panel.

### CROSS-REFERENCE TO RELATED APPLICATIONS

This application claims the benefit under 35 U.S.C. Section 119 of Korean Patent Application Serial No. 10-2012-0129901, entitled filed Nov. 16, 2012, which is hereby incorporated by reference in its entirety into this application.

### BACKGROUND

1. Field

The present disclosure relates to a method and apparatus for laminating a scintillator panel and an imaging device panel.

2. Description of the Related Art

In the case of medical X-ray photography, the digital radiation imaging devices have been widely used to identify the images using the radiation detectors without the use of the film.

The digital radiation imaging devices can be classified into a direct conversion method and an indirect conversion method, the direct conversion method is a method to implement the images by directly converting the irradiated X-ray into an electric signal and the indirect conversion method is a method to implement the images after converting the X-ray into the visible light and converting the visible light into the electric signal by using an imaging device such as a photodiode, a CMOS, a CCD, or the like.

In the case of the indirect conversion method, it utilizes a scintillator to convert the X-ray into the visible light and is classified into a direct method and an indirect method according to a method of integrating the scintillator and the imaging device. The direct method is to directly deposit the scintillator layer on the imaging device and the indirect method is to separately manufacture a scintillator panel obtained by depositing the scintillator layer on a substrate and to laminate it to the imaging device panel by using an adhesive.

In the indirect method, when the scintillator panel and the imaging device panel are combined, a method such as a double-sided tape lamination, an adhesive solution lamination and a vacuum lamination or the like has been used.

The double-sided tape lamination is a method to laminate the scintillator panel and the imaging device panel on both sides of the double-sided tape, respectively, this method may damage the imaging device panel and the light receiving element or the like due to the CsI column and particles when the pressure is applied for the lamination; and also, since the lamination is performed at the atmospheric, the moisture in the air may deteriorate the characteristics of CsI.

The adhesive solution lamination is a method to coat the adhesive solution on the scintillator panel or the lamination surface of the imaging device panel and to couple it the imaging device panel or the lamination surface of the scintillator panel to be laminated, since this method is also implemented in the atmospheric, the moisture in the air may deteriorate the characteristics of CsI.

In the double-sided tape lamination and the adhesive solution lamination, in order to prevent the CsI from being affected by the moisture in the air, a process of depositing a protection layer, which is to deposit the protection such as a polymer on the scintillator layer, may be added.

The vacuum lamination aligns the scintillator panel and the imaging device panel in the vacuum chamber to face each other and seals the edge thereof first. If the sealed scintillator panel and the imaging device panel are placed in the atmospheric, the opposite surfaces of the scintillator panel and the imaging device panel are pressurized to each other by the external pressure. However, in this method, since the opposite surfaces of the scintillator panel and the imaging device panel may be bent to the inside thereof by the external pressure, the optical path difference may occur in the visible light passing through the panels.

### SUMMARY

The present disclosure has been achieved in order to overcome the above-described problems of the conventional lamination methods and it is, therefore, an object of the present invention to provide an apparatus for laminating a scintillator panel and an imaging device panel to form the X-ray detecting device and a method thereof capable of allowing the opposite surfaces of the scintillator panel and the imaging device panel to maintain the degree of parallelization first, allowing an X-ray detecting device as an assembly obtained after the lamination to be stable in structure second and protecting a CsI from the moisture without additionally performing a process of depositing a protection layer on the scintillator panel third.

An laminating apparatus of the present invention to achieve the object includes a vacuum chamber, a membrane, a first vacuum pump, a heater plate, a heater power supply and a second vacuum pump or the like.

The vacuum chamber is provided with a chamber body and a chamber cover, wherein a sealed space is formed inside thereof.

The membrane is coupled to a bottom surface of the chamber cover and the sealed space is formed in the bottom surface of the chamber cover. And also, the membrane pressurizes a panel assembly of the scintillator panel and the imaging device panel with repeating the contraction and expansion when the sealed space is changed from the vacuum to the atmospheric.

The first vacuum pump is coupled to the chamber cover and adjusts the sealed space formed between the bottom surface of the chamber cover and the membrane to vacuum or atmospheric.

The heater plate is placed in the chamber body and supports the panel assembly inserting therein an adhesive sheet to heat.

The heater power supply supplies the power to the heater plate.

The second vacuum pump is coupled to the chamber body to form the vacuum in the chamber or vent the vacuum.

In the laminating apparatus of the present invention, the membrane is made of a material capable of contracting and expanding such as silicon, rubber or the like.

In the laminating apparatus of the present invention, the adhesive sheet is made of a thermoplastic sheet, for example, an ethylene vinyl acetate (EVA) sheet, a polycarbonate (PC) sheet, a polyvinyl butyral (PVB) sheet or a silicon based organic-thermoplastic sheet.

A method for laminating a scintillator panel and an imaging device panel includes closing a membrane to a bottom surface of a chamber cover, aligning a panel assembly to a heater plate, forming a vacuum in a chamber, heating a heater plate, pressurizing the panel assembly by expanding the membrane and curing the panel assembly.

In closing the membrane to the bottom surface of the chamber cover, a first vacuum pump forms a sealed space between the chamber cover and the membrane, wherein the membrane is in contact with the bottom surface of the chamber cover.

In aligning the panel assembly to the heater plate, the panel assembly is aligned to the heater plate in the chamber, wherein an adhesive sheet is inserted between the scintillator panel and the imaging device panel.

In forming the vacuum in the chamber, the chamber cover is close and the vacuum is formed in the chamber by using the second vacuum pump.

In heating the heater plate, the heater power supply applies the power to the heater plate, wherein the heater plate is heated to a predetermined temperature. If the heater plate is heated, the adhesive sheet inserted between the scintillator panel and the imaging device panel is melted.

In pressurizing the panel assembly by expanding the membrane, the sealed space between the bottom surface of the chamber cover and the membrane is formed into the atmospheric by using the first vacuum pump. In this case, the top surface of the panel assembly is pressurized while the membrane is expanded to a direction of the panel assembly; and, in this result, the scintillator panel and the imaging device panel are laminated by the adhesive sheet which is melted inside thereof.

In pressurizing the panel assembly by the membrane, the membrane sequentially pressurizes the panel assembly from a central region to an edge thereof. That is, the membrane swells like a balloon downward and pressurizes from the central region of the panel assembly first. The panel assembly pressurized from the central region is uniformly distributed between the scintillator panel and the imaging device panel while the melted adhesive sheet therein is extruded to a side surface.

In the laminating method, the membrane is made of a material capable of contracting and expanding, for example, a silicon, a rubber or the like, and the adhesive sheet is made of a thermoplastic sheet, for example, an ethylene vinyl acetate (EVA) sheet, a polycarbonate (PC) sheet, a polyvinyl butyral (PVB) sheet or a silicon based organic-thermoplastic sheet.

### BRIEF DESCRIPTION OF THE DRAWINGS

FIG. 1A is a cross-sectional view showing an laminating apparatus of an X-ray detecting device according to some embodiments of the present invention;

FIG. 1B is a cross-sectional view showing a state that a panel assembly is aligned in a vacuum chamber and a chamber cover is close in the laminating apparatus of the X-ray detecting device according to some embodiments of the present invention;

FIGS. 1C and 1D are views showing states that a membrane is expanded in the vacuum chamber in the laminating apparatus of the X-ray detecting device according to some embodiments of the present invention;

FIG. 1E is a cross-sectional view showing a state that a sealed space of the membrane becomes a vacuum and the vacuum is vented in the laminating apparatus of the X-ray detecting device according to some embodiments of the present invention;

FIG. 1F is a cross-sectional view showing a state that the chamber cover is open after finishing an laminating process in the laminating apparatus of the X-ray detecting device according to some embodiments of the present invention; and

FIG. 2 is a flowchart showing a method of laminating an X-ray detecting device according to some embodiments of the present invention.

### DETAILED DESCRIPTION OF THE PREFERABLE EMBODIMENTS

Exemplary embodiments of the present invention to achieve the above-described objects will be described with reference to the accompanying drawings. In this description, the same elements are represented by the same reference numerals, and additional description which is repeated or limits interpretation of the meaning of the invention may be omitted.

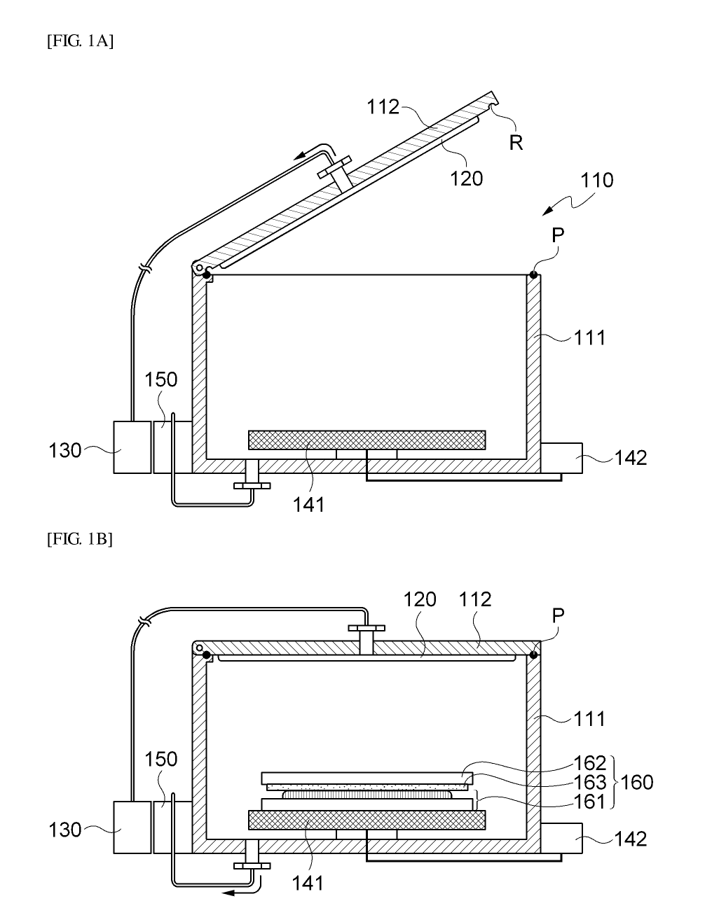

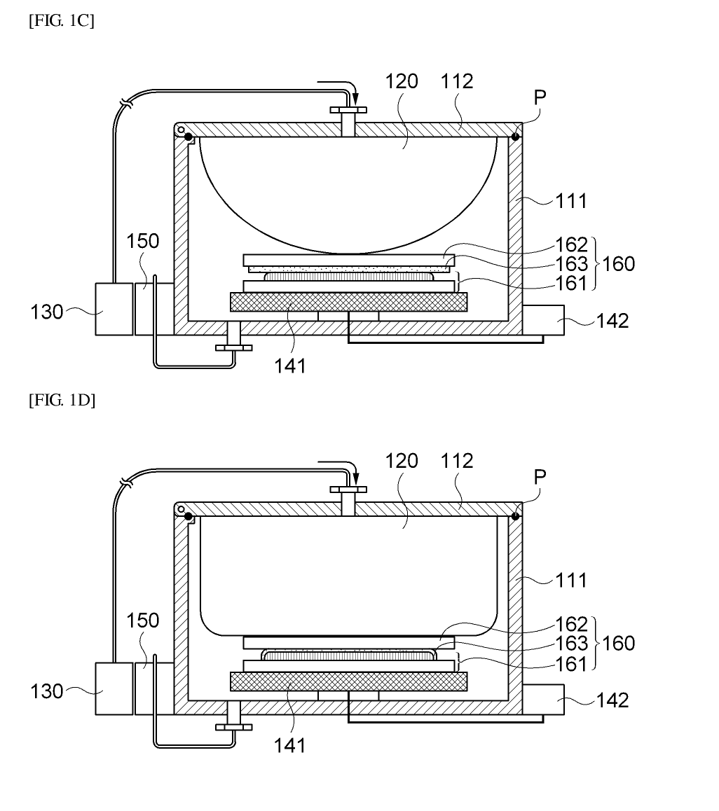

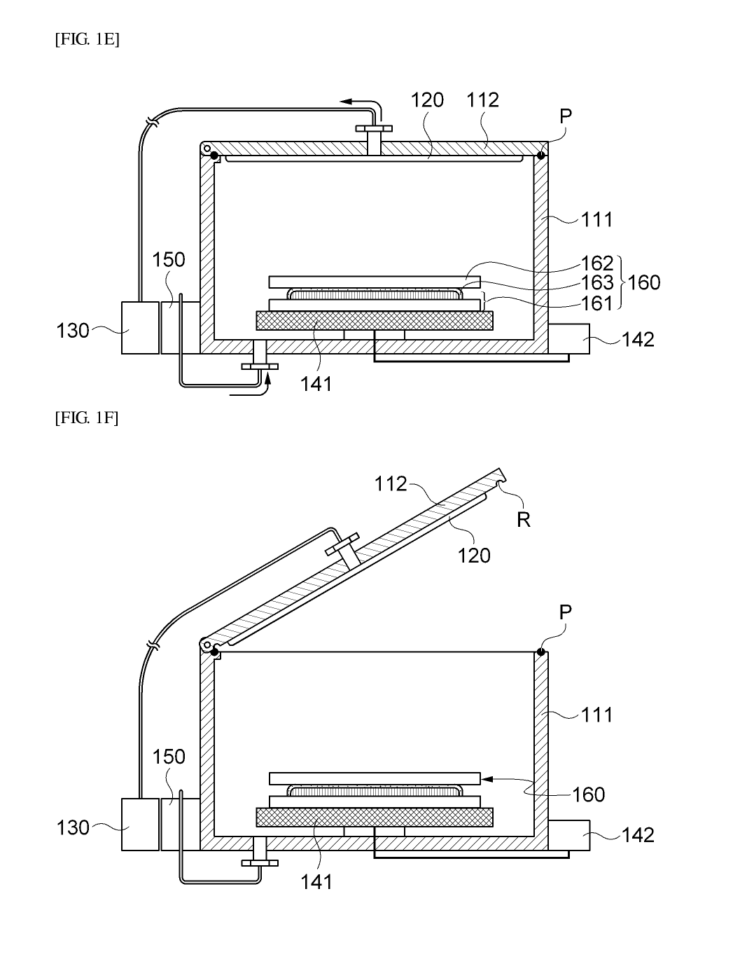

FIG. 1A is a cross-sectional view showing an laminating apparatus of an X-ray detecting device in accordance with an embodiment of the present invention.

As shown in FIG. 1A, the laminating apparatus of the X-ray detecting device of the present invention includes a vacuum chamber 110, a membrane 120, a first vacuum pump 130, a heater plate 141, a heater power supply 142, and a second vacuum pump 150.

The vacuum chamber 110 includes a chamber body 111 and a chamber cover 112, wherein a sealed space is formed according to an open and close state of the chamber cover 112.

The chamber body 111 is generally formed with a hexahedron case with a space therein. The chamber body 111 may be provided with an open and close driving unit or the like to mechanically open and close the chamber cover 112 and may be provided with a plurality of driving switches to drive the first vacuum pump 130, the heater power supply 142, and the second vacuum pump 150. And also, the chamber body 111 may be provided with a monitor to display an operation state therein or may be provided with a transparent window made of a transparent material to watch the inside thereof.

A sealing member P is formed on a top edge of the chamber body 111 to be in contact with an edge inside surface of the chamber cover 112. The sealing member P seals an interface surface between the chamber body 111 and the chamber cover 112 by being inserted into an insertion groove R formed on the chamber cover 112.

The chamber cover 112 is rotatably coupled to a top of the chamber body 111. One side wall is sealed and coupled to the chamber body 111 and the remaining walls are coupled to the sealing member P of the chamber body 111 to be opened and closed. The insertion groove R is formed on the bottom surface of the edge of the chamber cover 112 to insert the sealing member P of the chamber body 111.

The membrane 120 is coupled to a bottom surface of the chamber cover 112, i.e., the inner part of the insertion groove R. The edge of the membrane 120 coupled to the bottom surface of the chamber cover 112 forms a sealed space at the bottom surface of the chamber cover 112 by being coupled to the bottom surface of the chamber cover 112.

The membrane 120 is made of contractable and expandable material such as silicon or rubber. And also, since the membrane 120 pressurizes the heated panel assembly 160 during expanding, it is made of a material having a heat resistance.

The first vacuum pump 130 is coupled to the chamber cover 112 and the sealed space between the bottom surface of the chamber cover 112 and the membrane 120 becomes a vacuum or an atmospheric pressure. Although the first vacuum pump 130 may be constructed separately from the vacuum chamber 110 as shown in FIG. 1A, it can be constructed on a top portion, a side portion or a bottom portion of the vacuum chamber 110 integrally.

The heater plate 141 is placed the bottom portion in the vacuum chamber 110. The heater plate 141 fuses an adhesive sheet 163 interposed between a scintillator panel 161 and an imaging device panel 162 by heating the panel assembly 160. The heater plate 141 includes a plurality of heaters separated at a predetermined interval.

The heater power supply 142 is connected to the heater plate 141 and supplies the power to heat the heater plate 141. The temperature control of the heater plate 141 due to the heater power supply 142 can be constituted of a first step heating method and a second step heating method and the like. The first step heating method is a method of increasing a room temperature to a temperature at which the adhesive sheet 163 is melted and decreasing the increased temperature. The second step heating method includes a preliminary heat. That is, the temperature is increased to a stand-by state (about 110° C.) and decreased to the temperature at which the adhesive sheet 163 is melted after making the vacuum chamber 110 vacuum.

In the chamber body 111, for example, a temperature sensor can be provided within an inside wall of the chamber body 111 or the heater plate 141, the temperature sensor detects the temperature in the vacuum chamber 110, and, if the inside temperature is above an appropriate temperature, the power applied to the heater plate 141 is shut off by controlling the heater power supply 142.

The second vacuum pump 150 is coupled to the chamber body 111, for example, a bottom, and forms the vacuum or vents the vacuum in the vacuum chamber 110. Although the second vacuum pump 150 can be constructed separately from the vacuum chamber 110 as shown in FIG. 1A, it can be constructed on the bottom or the sides of the vacuum chamber 110 integrally.

FIG. 1B is a cross-sectional view showing a state that the panel assembly is aligned in a vacuum chamber and a chamber cover is close in the laminating apparatus of the X-ray detecting device in accordance with the embodiment of the present invention.

As shown in FIG. 1B, the panel assembly 160 is aligned on the heater plate 141, after the chamber cover 112 is closed, if the inside of the vacuum chamber 110 becomes vacuum by using the second vacuum pump 150, the preparation of laminating work of the panel assembly is completed.

As shown in FIG. 1B, the panel assembly 160 is constituted of the scintillator panel 161, the imaging device panel 162 and the adhesive sheet 163 interposed between the scintillator panel 161 and the imaging device panel 162.

The scintillator panel 161 includes a substrate, a reflection layer deposited on the substrate and a scintillator layer deposited on the reflection layer and the like.

The imaging device panel 162 is constituted of a substrate, a plurality of light receiving elements and electrode pads formed on the substrate and the like.

The panel assembly 160 is formed by facing the scintillator layer of the scintillator panel 161 to the light receiving element forming surface of the imaging device panel 162 and interposing the adhesive sheet therebetween.

The adhesive sheet 163 can be a thermoplastic adhesive sheet. The thermoplastic adhesive sheet can be an ethylene vinyl acetate (EVA) sheet, a polycarbonate (PC) sheet, a polyvinyl butyral (PVB) sheet or a silicon based organic-thermoplastic sheet or the like.

As a specific example of the EVA sheet, an adhesive sheet constituted by including an organic peroxide into an ethylene copolymer resin which is constituted of a vinyl acetate content of 30˜36% and a vinyl acetate content of 24˜30% at a ratio of 90:10˜10:90 can be used. Herein, the ethylene copolymer resin is constituted of 94˜99.5 weight % of the adhesive sheet. If the ethylene copolymer exceeds the 99.5 weight %, the problem not to be cured may be occurred; and, if the ethylene copolymer is below 94 weight %, the problem to deteriorate the adhesive strength may be occurred.

On the other hands, the ethylene copolymer may be an ethylene vinyl ester copolymer such as ethylene.acetate vinyl copolymer, an ethylene.unsaturated carboxylic acid ester copolymer such as an ethylene.acrylic acid methyl copolymer, an ethylene.acrylic acid ethyl copolymer, an ethylene.meta acrylic acid copolymer, an ethylene.acrylic acid isobutyl copolymer and an ethylene.acryl acid n-butyl, and an ethylene.unsaturated carboxylic acid copolymer, an ethylene.meta acrylic acid copolymer, an ethylene.acrylic acid isobutyl.meta acrylic acid copolymer, it is preferable to use the ethylene.acetate vinyl copolymer considering on the suitability of the adhesive sheet requirement material property such as a formability, a transparency, a flexibility, an adhesive property, a light stability or the like.

The commercially available ethylene.acetate vinyl copolymer is a MA-10(the vinyl acetate content is 32% and the melt flow rate is 40 g/10 minutes), a KA-40(the vinyl acetate content is 28% and the melt flow rate is 20 g/10 minutes) supplied TPC, a PV 1650(the vinyl acetate content is 33% and the melt flow rate is 31 g/10 minutes), a PV 1400(the vinyl acetate content is 32% and the melt flow rate is 43 g/10 minutes), a PV 1410(the vinyl acetate content is 32% and the melt flow rate is 43 g/10 minutes) manufactured by DuPont or the like.

The organic peroxide can be used by selecting one of a dialkyl peroxides type, an alkyl peroxide ester type or a peroxy ketone type. The organic peroxide can use 0.2˜4 weight % for the 100 weight % of the ethylene copolymer resin. If the amount of used organic peroxide is below 0.2 weight %, there is a problem that the ethylene copolymer resin is not sufficiently cross-linked, and, although the cross-linked speed can be increased with exceeding 4 weight %, there may occur a problem that the percentage of contraction increases.

In the melting lamination of the panel assembly, the adhesive sheet passes through a vacuum process during 6 minutes at 130° C. and a pressing process during 1 minute. Thereafter, a curing process is performed in an oven at a temperature of 150° C. during approximately 40 minutes. Herein, the temperature and the time can be changed according to the material of the adhesive sheet or the type of the chamber as well as according to the operator.

FIGS. 1C and 1D are views showing states that a membrane is expanded in the vacuum chamber in the laminating apparatus of the X-ray detecting device in accordance with the embodiment of the present invention.

As shown in FIG. 1C, if the sealed space between the membrane 120 and the bottom surface of the chamber cover 112 changes from the vacuum to the atmospheric, the sealed space swells like a balloon by the air introduced therein. When the sealed space swells, the membrane 120 is in contact with the top surface of the panel assembly 160 from the bottom central portion thereof.

Thereafter, as shown in FIG. 1D, if the air further introduces into the sealed space between the membrane 120 and the bottom surface of the chamber cover 112, the membrane 120 sequentially pressurizes the panel assembly 160 with moving from the central region to the edge thereof. Finally, the membrane 120 pressurizes the whole top surface of the panel assembly 160. Like this, the sequential pressurization of the membrane 120 pressurizes the melt laminating sheet inside of the panel assembly from the center to the edge; and, in this results, it is dense and evenly distributed between the scintillator panel 161 and the imaging device panel 162.

FIG. 1E is a cross-sectional view showing a state that a sealed space of the membrane becomes a vacuum and the vacuum is vented in the laminating apparatus of the X-ray detecting device in accordance with the embodiment of the present invention; and FIG. 1F is a cross-sectional view showing a state that the chamber cover is open after finishing an laminating process in the laminating apparatus of the X-ray detecting device in accordance with the embodiment of the present invention.

As shown in FIGS. 1E and 1F, if the pressurization of the panel assembly 160 is finished, the membrane 120 is in contact with the bottom surface of the chamber cover 112 by making the sealed space between the chamber cover 112 and the membrane 120 with a vacuum. In parallel with or subsequently, the vacuum inside of the vacuum chamber 110 is vented by using the second vacuum pump 150 and the chamber cover 112 is open. Before, the curing process may be performed in the vacuum chamber 110. Or, after the laminated panel assembly 160 is moved into an additional curing chamber, the curing process may be performed.

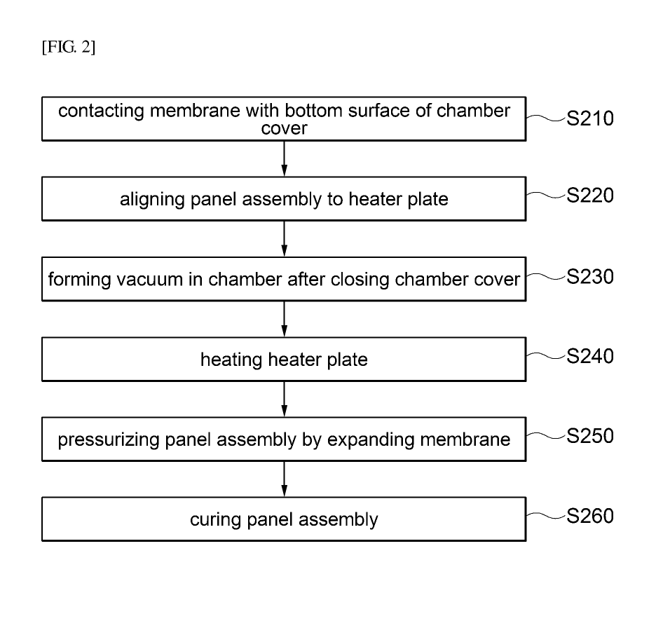

FIG. 2 is a flowchart showing a method of laminating an X-ray detecting device according to some embodiments of the present invention.

As shown in FIG. 2, the lamination of a scintillator panel and an imaging device panel according to some embodiments the present invention includes a step (S210) of contacting a membrane with a bottom surface of a chamber cover, a step (S220) of aligning a panel assembly to a heater plate, a step (S230) of forming a vacuum in a chamber after closing the chamber cover, a step (S240) of heating the heater plate, a step (S250) of pressurizing the panel assembly by expanding the membrane and a step (S260) of curing the panel assembly.

The step (S210) of contacting the membrane 120 with the bottom surface of the chamber cover 112 forms the vacuum in the sealed space between the chamber cover 112 and the membrane 120 by using the first vacuum pump 130 connected to the chamber cover 112 under the state that the chamber cover 112 is open. In this case, the membrane 120 is in contact with the inside surface of the chamber cover 112.

The step (S220) of aligning the panel assembly 160 to the heater plate 141 aligns the panel assembly 160, in which an adhesive sheet 163 is interposed between the scintillator panel 161 and the imaging device panel 162 under the condition that the chamber cover 112 is open, on the heater plate 141 in the vacuum chamber 110. In this case, the scintillator panel 161 can directly pressurize the membrane 120 and the imaging device panel 162 also can do.

The step (S230) forming the vacuum in the chamber after closing the chamber cover 112 forms the vacuum in the vacuum chamber 110 using the second vacuum pump 150 connected to the chamber body 111.

The step (S240) of heating the heater plate 141 heats the heater plate 141 to a predetermined temperature after forming the vacuum in the chamber by applying the power to the heater plate 141. If the heater plate 141 is heated during a predetermined time, the adhesive sheet 163 interposed between the scintillator panel 161 and the imaging device panel 162 is melted. In case when a temperature sensor is provided in the vacuum chamber 110, while the temperature is detected in the vacuum chamber 110 using the temperature sensor, the heater plate 141 is heated until the adhesive sheet 163 is completely melted.

The step (S250) of pressurizing the panel assembly 160 by expanding the membrane 120 pressurizes the scintillator panel 161 or the outside surface of the imaging device panel 162 so as to couple the melted adhesive sheet 163 with the scintillator panel 161 and the imaging device panel 162. If the vacuum between the bottom surface of the chamber cover 112 and the membrane 120 is smoothly vented by using the first vacuum pump 130, the top surface of the panel assembly 160 is pressurized while the membrane 120 is expanded to the direction of the panel assembly 160, and, in this result, the scintillator panel 161 and the imaging device panel 162 are laminated by the melted adhesive sheet 163 therein.

In the step (S250) of pressurizing the panel assembly 160 by expanding the membrane 120, the membrane 120 sequentially pressurizes the panel assembly 160 from the central region to the edge thereof. That is, the membrane 120 swells to the bottom in a shape of balloon, and, therefore, it becomes in contact with the central region of the panel assembly 160 first and pressurizes. The panel assembly 160 pressurized from the central region is uniformly distributed between the scintillator panel 161 and the imaging device panel 162 while the melted adhesive sheet 163 therein is extruded to a side surface.

The membrane 120 is made of a material capable of expanding/contracting, e.g., a film made of a silicon or a rubber, and the adhesive sheet is made of a thermoplastic sheet, e.g., an ethylene vinyl acetate (EVA) sheet, a polycarbonate (PC) sheet, a polyvinyl butyral (PVB) sheet or a silicon based organic-thermoplastic sheet or the like.

The pressurized panel assembly 160 moves into the vacuum chamber 110 or an additional curing chamber and is cured under the condition of predetermined temperature and time (S260).

With the laminating apparatus and laminating method according to some embodiments the present invention having such constitution elements and steps, it is possible to prevent the resolution from being deteriorated due to the optical path difference since the degree of parallelization between the scintillator panel and the imaging device panel can be maintained. And also, even after the scintillator panel and the imaging device panel are laminated, since the cured adhesive sheet is filled between the scintillator panel and the imaging device panel, the X-ray detecting device can be structurally stable. In addition, since the processes are performed in the vacuum chamber, there is no need to an additional process to deposit a protection film on the scintillator layer. In this result, the manufacturing process can be simplified and the structure of the X-ray detecting device can be simplified.

The above-described embodiments and the accompanying drawings are provided as examples to help understanding of those skilled in the art, not limiting the scope of the present disclosure. Further, embodiments according to various combinations of the above-described components will be apparently implemented from the foregoing specific descriptions by those skilled in the art. Therefore, the various embodiments of the present disclosure may be embodied in different forms in a range without departing from the essential concept of the present disclosure, and the scope of the present disclosure should be interpreted from the subject matter defined in the claims. It is to be understood that the present disclosure includes various modifications, substitutions, and equivalents by those skilled in the art.

1. A method of laminating a scintillator panel and an imaging device panel, the method comprising:
forming a vacuum between a bottom surface of a chamber cover and a membrane, the membrane being coupled to the bottom surface of the chamber cover to define a sealed space;
aligning a panel assembly including the scintillator panel, the imaging device panel, and an adhesive between the scintillator panel and the imaging device panel to a heater plate inside a chamber;
closing the chamber cover and forming a vacuum inside the chamber;
heating the heater plate; and
venting the vacuum between the bottom surface of the chamber cover and the membrane such that the membrane pressurizes the panel assembly.

2. The method according to claim 1, wherein the membrane pressurizes the panel assembly from a center to an edge of the panel assembly sequentially.

3. The method according to claim 1, wherein the membrane comprises silicone.

4. The method according to claim 1, wherein the membrane comprises rubber.

5. The method according to claim 1, wherein the adhesive comprises thermoplastic.

6. The method according to claim 5, wherein the adhesive comprises at least one sheet selected from the group consisting of an ethylene vinyl acetate (EVA) sheet, a polycarbonate (PC) sheet, a polyvinyl butyral (PVB) sheet, and a silicon-based organic thermoplastic sheet.

7. The method according to claim 1, further comprising detecting a temperature inside the chamber by using a temperature sensor.

8. An apparatus for laminating a scintillator panel and an imaging device panel, the apparatus comprising:
a chamber including a chamber cover for defining a sealed space;
a membrane coupled to a bottom surface of the chamber cover for defining the sealed space at the bottom surface of the chamber cover, wherein the membrane is contractable and expandable;
a first vacuum pump coupled to the chamber cover for forming a vacuum in the sealed space;
a heater plate coupled into the chamber for supporting and heating a panel assembly including the scintillator panel, the imaging device panel, and an adhesive between the scintillator panel and the imaging device panel;
a heater power supply for applying a power to the heater plate; and
a second vacuum pump coupled to one side of the chamber for forming a vacuum in the chamber.

9. The apparatus according to claim 8, wherein the membrane comprises silicon.

10. The apparatus according to claim 8, wherein the membrane comprises rubber.

11. The apparatus according to claim 8, wherein the adhesive comprises thermoplastic.

12. The apparatus according to claim 11, wherein the adhesive comprises at least one sheet selected from the group consisting of an ethylene vinyl acetate (EVA) sheet, a polycarbonate (PC) sheet, a polyvinyl butyral (PVB) sheet, and a silicon-based organic thermoplastic sheet.

13. The apparatus according to claim 8, further comprising a temperature sensor for detecting a temperature inside the chamber.
